(19) United States
(12) Patent Application Publication
(10) Pub. No.: US 2022/0327816 A1
(43) Pub. Date: Oct. 13, 2022

(54) SYSTEM FOR TRAINING MACHINE LEARNING MODEL WHICH RECOGNIZES CHARACTERS OF TEXT IMAGES

(71) Applicant: Hitachi, Ltd., Tokyo (JP)

(72) Inventors: Congkha NGUYEN, Tokyo (JP); Ryosuke ODATE, Tokyo (JP)

(21) Appl. No.: 17/714,322

(22) Filed: Apr. 6, 2022

(30) Foreign Application Priority Data
Apr. 9, 2021 (JP) 2021-066477

(51) Int. Cl. G06V 10/82; G06V 30/148; G06V 10/764; G06V 30/18

(52) U.S. Cl. CPC G06V 10/82; G06V 30/148; G06V 10/764; G06V 30/18

(57) ABSTRACT

A system trains a machine learning model which recognizes characters of text images. The system stores the machine learning model which recognizes characters of text images. The machine learning model includes a character segmentation network which is configured to extract visual features from text images, and to generate character bounding boxes from the text images, a domain adaptation network configured to classify the text images into domains based on the visual features, and a text recognition network configured to recognize characters in the text images based on the character bounding boxes and the visual features. The system is configured to (1) reverse gradients in the training of the domain adaptation network to minus gradients and back-propagate the minus gradients through the character segmentation network (2) back-propagate gradients in the training of the text recognition network through the character segmentation network.

### CLAIM OF PRIORITY

The present application claims priority from Japanese patent application JP2021-066477 filed on Apr. 9, 2021, the content of which is hereby incorporated by reference into this application.

### BACKGROUND

The present disclosure relates to text-image recognition.

In recent years, use of text-image recognition systems to automatically recognize various kinds of documents in order to improve work efficiency has become widespread in a large number of fields including retail, government, education, transport, logistics, and healthcare. With great progress in deep learning, text-image recognition technologies have been gradually improved, and some success has been achieved on specific data by, for example, recognizing scene text data with recognition rates of more than 90% as described in Chen, Xiaoxue, Lianwen Jin, Yuanzhi Zhu, Canjie Luo, and Tianwei Wang “Text Recognition in the Wild: A Survey” arXiv preprint arXiv:2005.03492 (2020).

Training of a deep learning model basically requires a large amount of labeled data in the same manner as in a case of a text-image recognition model. This point is one of the bottlenecks of deep-leaning-based systems. In view of this, there is a strong demand for a robust model that can recognize various kinds of documents even by being simply trained through the use of a small amount of another kind of text-labeled documents.

This is called “multi-domain adaptation” in which each domain is a kind of document. This reduces the costs of labeling data for training, expanding systems, and supporting individual clients. There have been proposed many solutions for building such a text-image recognition model, and, for example, data augmentation, transfer learning, and invariant feature learning are used. However, building such a text-image recognition model as described above is still a great challenge due to a diversity of testing data including fonts, handwriting styles, backgrounds, and character layouts.

With the rapid progress of deep learning, an approach based on a convolutional neural network (CNN), a long short-term memory (LSTM), and connectionist temporal classification (CTC) has been proposed, and this approach has been achieved performances higher than those of related-art approaches. The above-mentioned approach is robust to complex backgrounds and handwriting styles, and can perform end-to-end training without breaking a training process into smaller stages as in the related-art methods.

One of the problems with this approach is the fact that the independence of time-step features in the LSTM is assumed when an output label is estimated. This is known as a hard alignment problem that lowers the accuracy of the model. An approach based on an attention mechanism has recently been proposed to solve this problem. In this method, the model learns a position at which attention is paid to an encoded visual feature for each element of an output sequence by a fully connected layer.

This attention mechanism is originally provided for sequence-to-sequence translation in which one element of the output sequence can be aligned with any encoded visual feature. Due to this flexibility, when, in particular, long-text images or length-varying encoded visual features and output sequences are recognized, a character in an output sequence can be erroneously aligned (subjected to alignment) with a non-character feature or another character feature. This is known as a misalignment problem in the attention mechanism.

With regard to the related art, in Zhang, Yaping, Shuai Nie, Wenju Liu, Xing Xu, Dongxiang Zhang, and Heng Tao Shen “Sequence-to-sequence domain adaptation network for robust text-image recognition” In Proceedings of the IEEE Conference on Computer Vision and Pattern Recognition, pp. 2740-2749. 2019, there is proposed a domain adaptation method for text-image recognition. This method is based on the above-mentioned attention mechanism. A workflow of this method is as follows.

Text images of a source domain and a target domain are fed into some convolutional layers, and features are extracted therefrom. The source domain includes text-labeled images, and the target domain is used for testing images without text labels. An attention unit is used to align each character in an output sequence with an encoded visual feature of an image of the source domain. Then, a decoder is employed to decode the encoded visual feature into an output sequence. The above-mentioned steps are steps for text-image recognition.

In order to generalize a text-image recognition model for target domains, it is required to extract character-level features rather than whole text-image features because text images often include complex backgrounds and character patterns of various styles. The attention unit pays attention to character positions in the text images of the source domain and the target domain, and extracts character-level features at the attention positions. Character-level feature spaces of a source domain image and a target domain image are aligned by a distance function. Training gradients of feature space alignment are back-propagated to the shared-weighted attention unit, and hence the attention unit is adapted to the target domains.

The problem with this approach is that the attention mechanism is ideally premised on functioning well for character-level feature extraction. However, this is limited by such a misalignment problem of the attention mechanism as described above. In addition, the alignment of the character-level feature spaces of the two domains by the distance function may not be effective. This is because the text content of the source domain images and the text content of the target domain images, which are simultaneously fed into the model in each training iteration, are different from each other. The misalignment problem of the attention unit adversely affects the recognition accuracy of the text-image recognition model.

In Zhang, Yaping, Shuai Nie, Wenju Liu, Xing Xu, Dongxiang Zhang, and Heng Tao Shen “Sequence-to-sequence domain adaptation network for robust text-image recognition” In Proceedings of the IEEE Conference on Computer Vision and Pattern Recognition, pp. 2740-2749. 2019, an approach of domain adaptation of text-image recognition is presented. An attention unit is used to pay attention to character positions and extract character-level features for training domain adaptation.

Due to the misalignment problem, the attention unit as described in Zhang, Yaping, Shuai Nie, Wenju Liu, Xing Xu, Dongxiang Zhang, and Heng Tao Shen “Sequence-to-sequence domain adaptation network for robust text-image recognition” In Proceedings of the IEEE Conference on Computer Vision and Pattern Recognition, pp. 2740-2749. 2019 cannot extract character-level features well. This attention unit extracts character-level features, and then uses the distance function to align character-level feature spaces of the source domain and the target domain. This is not effective due to differences between the content of text images of the source domain and the content of text images of the target domain.

The misalignment problem in a text-image recognition method based on the related-art attention mechanism lowers the recognition accuracy of text-image recognition models. Therefore, a technology for improving the recognition accuracy of the text-image recognition model with a smaller amount of training labelled data is desired.

### SUMMARY

An aspect of this disclosure is a system for training a machine learning model which recognizes characters of text images. The system includes: one or more processors; and one or more storage devices. The one or more storage devices store the machine learning model which recognizes characters of text images. The machine learning model which recognizes characters of text images includes: a character segmentation network which is configured to extract visual features from text images, and to generate character bounding boxes from the text images; a domain adaptation network configured to classify text images into domains based on the visual features; and a text recognition network configured to recognize characters in the text images based on the character bounding boxes and the visual features. The one or more processors are configured to: reverse gradients in training of the domain adaptation network to minus gradients, and to back-propagate the minus gradients through the character segmentation network; and back-propagate a gradient in the training of the text recognition network through the character segmentation network.

An aspect of this disclosure improves the recognition accuracy of the text-image recognition model when recognizing text images of a new domain with a smaller amount of training labeled data.

### BRIEF DESCRIPTION OF THE DRAWINGS

FIG. 1 is an illustration of an overview of the training of a multi-domain adaptation character recognition model in at least one embodiment of the present specification.

FIG. 2 is an illustration of an example of input data.

FIG. 3 is an illustration of a hardware configuration example of a text-image recognition system according to at least one embodiment of the present specification.

FIG. 4 is a block diagram for illustrating a detailed configuration of the character segmentation network in at least one embodiment of the present specification.

FIG. 5 is a block diagram for illustrating a detailed configuration of the multi-domain adaptation network in at least one embodiment of the present specification.

FIG. 6 is a block diagram for illustrating a detailed configuration of the text recognition network in at least one embodiment of the present specification.

FIG. 7 is an illustration of an example of a revising GUI for revising results obtained by the character segmentation network, the multi-domain adaptation network, and the text recognition network.

FIG. 8 is an illustration of an example of metadata files for input training data and output testing data.

### DETAILED DESCRIPTION OF EMBODIMENTS

The following description of the present disclosure is divided into a plurality of sections or a plurality of embodiments if necessary for convenience. However, unless explicitly noted otherwise, the embodiments or sections are not irrelevant to one another, and one is related to another as a modification example, a detailed or supplementary description, or the like of a part of or the entirety of another. When the count of pieces of a component or the like (including the count, numerical value, amount, and range of a component) is mentioned in the following description of the present disclosure, the present disclosure is not limited to the particular count mentioned, and the component count can be higher or lower than the particular count, unless explicitly noted otherwise or unless it is theoretically obvious that the component count is limited to the particular count.

This system may be a physical computer system (one or more physical computers) or may be a system built on a computational resource group (a plurality of computational resources) such as cloud infrastructure. The computer system or the computational resource group includes one or more interface apparatus (including, for example, a communication apparatus and an input/output apparatus), one or more storage devices (including, for example, a memory (main memory) and an auxiliary storage device), and one or more processors.

When a function is implemented by a program being executed by the processor, defined processing is appropriately performed through the use of, for example, a storage device and/or an interface apparatus, and hence the function may be set as at least a part of the processor. Processing described with a function being used as a subject of a sentence may be set as processing performed by the processor or a system including the processor. The program may be installed from a program source. The program source may be, for example, a program distribution computer or a computer-readable storage medium (for example, a computer-readable non-transitory storage medium). Description of each function is merely an example, and a plurality of functions may be combined into one function, or one function may be divided into a plurality of functions.

According to at least one embodiment of the present specification, a character segmentation network is used to extract character-level features for training in multi-domain adaptation. A domain discriminator including several fully connected layers is used to encourage domain adaptation. The domain discriminator includes trainable layers, and can store character-level features for the next training iterations in comparison to the hard distance function.

According to at least one embodiment of the present specification, results of character segmentation are used to guide attention positions in text images (visual features of text images) for recognition. This can prevent the misalignment problem from adversely affecting the recognition accuracy of a text-image recognition model. With an approach using a multi-domain adaptation network and character segmentation, the model can be generalized for various kinds of text-images as well as being capable of achieving highly accurate character recognition.

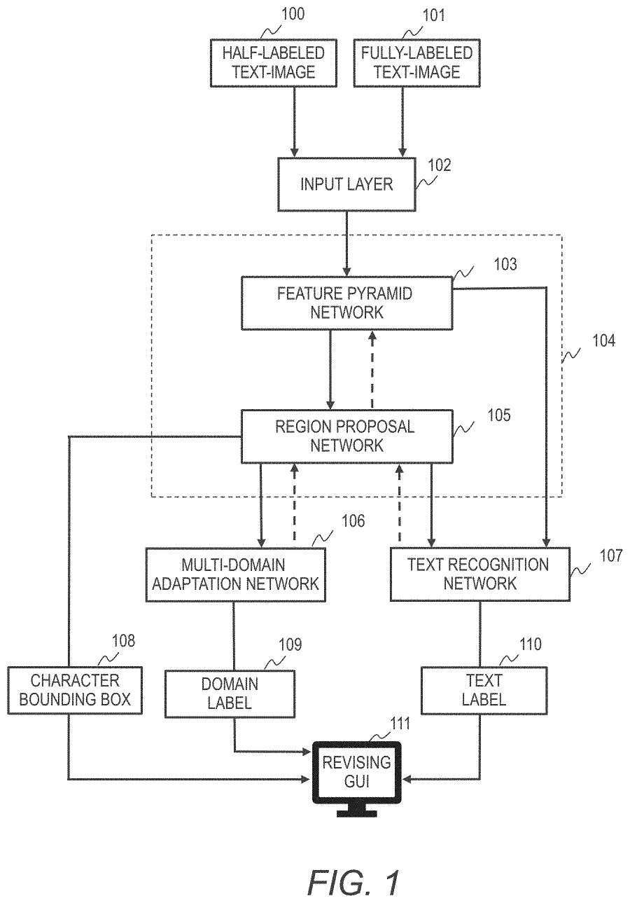

Now, at least one embodiment of the present specification is described regarding the accompanying drawings. FIG. 1 is an illustration of an overview of training of a multi-domain adaptation character recognition model in at least one embodiment of the present specification. The solid arrows indicate data including features fed or forwarded between layers or between blocks. The dashed arrows indicate gradient backpropagation. The same applies to the other drawings. In an operational phase, the multi-domain adaptation character recognition model extracts characters from unlabeled text images.

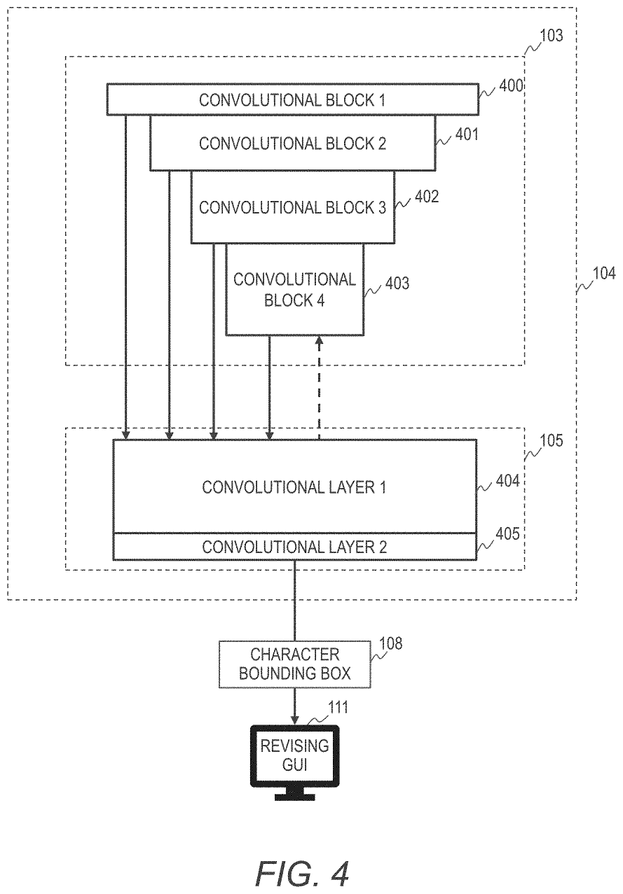

The multi-domain adaptation character recognition model includes three components, which are a character segmentation network 104, a multi-domain adaptation network 106, and a text recognition network 107. Details of the processing of each network are described later regarding FIG. 4 to FIG. 6.

The character segmentation network 104 is shared by the multi-domain adaptation network 106 and the text recognition network 107. The multi-domain adaptation character recognition model adjusts weights in each training iteration to learn features for text-image recognition and domain adaptation.

The multi-domain adaptation network 106 learns to discriminate domains of input images. The gradients in training the multi-domain adaptation network 106 are back-propagated to the shared-weighted character segmentation network 104 in each learning iteration so that the model is generalized to recognize various kinds of text images.

The multi-domain adaptation network 106 is updated by gradient back-propagation so that errors of domain classification results (domain classification errors) become smaller. The multi-domain adaptation network 106 includes a gradient reversal layer in which a minus gradient (−gradient) is back-propagated through the character segmentation network 104. This enables the character segmentation network 104 to learn invariant features of text images in various domains.

The text recognition network 107 recognizes input images from the features extracted by the character segmentation network 104. The text recognition network 107 uses the results of the character segmentation network 104. The results of the character segmentation network guide attention positions for the text recognition network 107. This can improve the recognition accuracy of a text-image recognition model.

The text recognition network 107 is updated by gradient back-propagation so that errors of character recognition results (character recognition errors) become smaller. The gradients in training the text recognition network 107 are backpropagated through the character segmentation network 104 without being reversed. This enables the character segmentation network 104 to learn features of characters to be recognized.

For each iteration of iterative training (also referred to as “training iteration”), two kinds of text images are fed to an input layer 102 of the domain adaptation text-image recognition model. Text images of one kind are labeled domain names thereof. Those are referred to as “half-labeled text-images 100.” Text images of the other kind are labeled characters and domain names, and are further annotated with character bounding boxes. Those are referred to as “fully-labeled text-images 101.”

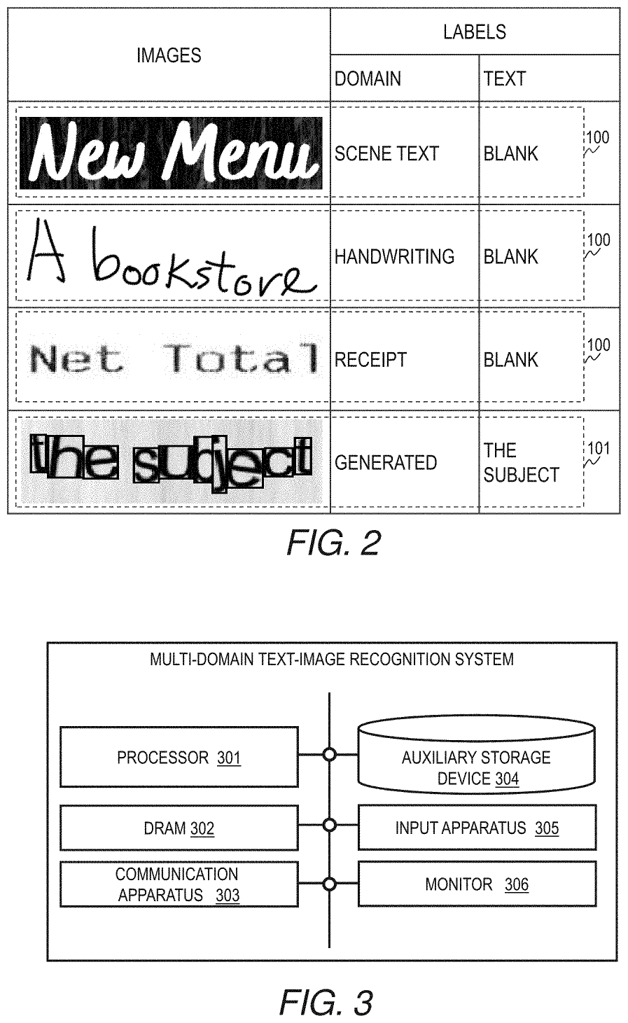

FIG. 2 is an illustration of an example of input data. FIG. 2 is an illustration of an example of two kinds of input data that are input in each training iteration. In FIG. 2, three half-labeled text-images 100 and one fully-labeled text-image 101 are illustrated.

The half-labeled text-image 100 includes an image and a domain label corresponding with the image. In FIG. 2, the three images are given with domain labels of “Scene text,” “Handwriting,” and “Receipt.”

The fully-labeled text-image 101 includes an image, a domain label and a text label that are corresponding with the image. The fully-labeled text-image 101 illustrated in FIG. 2 has a classification indicating a generated text-image (also referred as “a generated text-image”) and a text label of “the subject.” Such a fully-labeled text-image 101 can be generated from available fonts and text. It is possible to easily acquire text labels, domain labels, and character bounding boxes.

In the example of FIG. 2, one character bounding box is assigned to one character. Each character bounding box encloses a single character, to thereby be able to improve character recognition accuracy. In another example, the bounding box may enclose a plurality of characters.

The fully-labeled text-image 101 and the half-labeled text-image 100 have different convolutional feature distributions. The multi-domain adaptation character recognition model in at least one embodiment of the present specification is trained by fully-labeled text-images of some domains, to thereby be able to recognize half-labeled text-images of other domains.

In the example of FIG. 2, the multi-domain adaptation character recognition model is trained by the fully-labeled text-image of the generated text-image domain, to thereby be able to recognize half-labeled text-images of other domains including handwriting text-images, scene text-images, and receipt text-images.

The fully-labeled text-images may be any kinds of text images that are available text labels, domain labels, and character bounding boxes. Fully-labeled text-images of more domains improve the recognition accuracy of the multi-domain adaptation character recognition model. As the half-labeled text-images, for example, text-images (of all domains) that are required to be recognized without provided text labels and character bounding boxes.

FIG. 3 is an illustration of a hardware configuration example of a text-image recognition system according to at least one embodiment of the present specification. A multi-domain text-image recognition model described with reference to FIG. 1 can be implemented in the text-image recognition system. The text-image recognition system executes character recognition of text images input by the multi-domain text-image recognition model, and further executes training (learning) of the multi-domain text-image recognition model.

The text-image recognition system can have, for example, a computer configuration. The text-image recognition system includes a processor 301 having arithmetic performance and a DRAM 302 being a main storage device that provides a volatile temporary storage area for storing a program to be executed by the processor 301 and data therefor. The text-image recognition system further includes an auxiliary storage device 304 that provides a permanent information storage area through use of, for example, a hard disk drive (HDD) or a flash memory. The DRAM 302, the auxiliary storage device 304, and a combination thereof are each a storage device.

The text-image recognition system further includes a communication apparatus 303 for performing data communication to/from another apparatus, an input apparatus 305 for receiving an operation from a user, and a monitor 306 (example of an output apparatus) for presenting an output result of each process to the user. Those components can communicate to/from each other through a bus. Each of the components of the text-image recognition system is provided in any number, and some components, such as the input apparatus 305 and the monitor 306, may be omitted.

The components described with reference to FIG. 1 can be implemented by, for example, the processor 301 for executing a program including an instruction code. The program for implementing functional modules is stored in, for example, the auxiliary storage device 304. The program to be executed by the processor 301 and the data to be processed thereby are loaded from the auxiliary storage device 304 into the DRAM 302. Functions in the system may be implemented by circuits for specific functions instead of a processor that operates in accordance with the program.

The text-image recognition system may be such a physical computer system (one or more physical computers) as illustrated in FIG. 3, or may be a system built on a computational resource group (a plurality of computational resources) such as cloud infrastructure. The computer system or the computational resource group includes one or more interface apparatus (including, for example, a communication apparatus and an input/output apparatus), one or more storage devices (including, for example, a memory (main memory) and an auxiliary storage device), and one or more processors.

When a function is implemented by the program being executed by the processor, defined processing is appropriately performed through the use of, for example, the storage device and/or the interface apparatus, and hence the function may be set as at least a part of the processor. Processing described with a function being used as a subject of a sentence may be set as processing performed by the processor or the system including the processor.

The program may be installed from a program source. The program source may be, for example, a program distribution computer or a computer-readable storage medium (for example, a computer-readable non-transitory storage medium). Description of each function is merely an example, and a plurality of functions may be combined into one function, or one function may be divided into a plurality of functions.

FIG. 4 is a block diagram for illustrating a detailed configuration of the character segmentation network 104 in at least one embodiment of the present specification. Both fully-labeled text-images and half-labeled text-images are fed into the character segmentation network 104 including two sub-networks. The two sub-networks are a feature pyramid network (FPN) 103 and a region proposal network (RPN) 105.

Features of input images are extracted at four concatenated deep levels 400 to 403 of the FPN. Examples of the FPN include VGGNet including sequential convolutional layers, ResNet formed of a plurality of residual blocks, or any down-sampling convolutional neural network (CNN). VGGNet, ResNet, and U-Net are known technologies, and detailed descriptions thereof are omitted. Features can be extracted at one or more deep levels. The deep levels can vary in, for example, receptive field and resolution.

Features at each of the levels 400 to 403 are input to two convolutional layers 404 and 405. Specifically, the features of levels 400 to 403 are input to the convolutional layer 1 (404), and output from the convolutional layer 1 (404) is input to the convolutional layer 2 (405).

The region proposal network 105 evaluates character regions on each of the feature levels 400 to 403, combines results of the evaluation for all feature levels, and discards overlapping character regions. A loss of the character bounding boxes is calculated for fully-labeled text-images. A loss function Lc is an L1 loss function. Character segmentation results 108 can be examined, revised, and saved by a revising GUI 111. The modified character bounding box may be used for the next training iterations. This character segmentation processing is known as instance segmentation. In another example, semantic segmentation may be used.

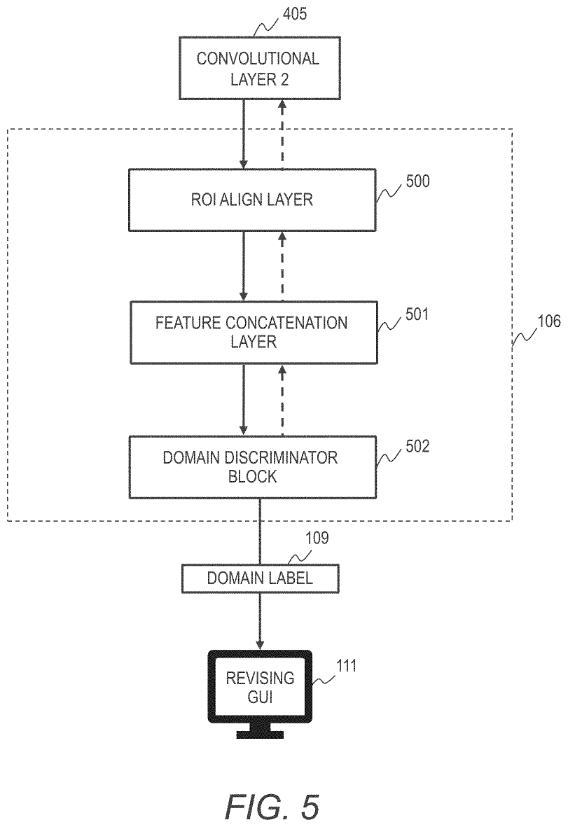

FIG. 5 is a block diagram for illustrating a detailed configuration of the multi-domain adaptation network 106 in at least one embodiment of the present specification. FIG. 5 is an illustration of a structural example of a convolutional neural network for multi-domain adaptation. The bounding boxes 108 of character patterns of the half-labeled text-images 100 and the fully-labeled text-images 101 that have been proposed by the region proposal network 105 are matched to feature maps at the deep levels 400 to 403, and character-level features are acquired. The feature maps at the deep levels 400 to 403 and the bounding boxes 108 are input to the multi-domain adaptation network 106.

Compared to using a related-art attention unit to extract character-level features, the character segmentation network 104 determines an anchor box for identifying a character position. Thus, a visual feature can be uniquely adjusted to the character position with efficiency. Meanwhile, the related-art attention unit freely adjusts the visual feature to the character position.

The character-level features are passed into a region-of-interest (RoI) align layer 500. The RoI align layer 500 is a layer for extracting feature maps corresponding to character bounding boxes from the feature maps by RoI align. The RoI align layer 500 can use bilinear interpolation and max/average pooling. At the RoI align layer 500, character-level feature maps are rescaled to the same size. The size is defined in advance. The feature maps are concatenated along a specific axis by a feature concatenation layer 501. This enables highly accurate domain classification.

The RoI align layer 500 can also be replaced by a region of interest pooling (RoI pooling). However, the RoI pooling exhibits less performance than the RoI align. A domain discriminator block 502 can be formed of several fully connected layers and a softmax layer. In the training, the extracted character-level features are used to classify half-labeled text images and fully-labeled text images into domains corresponding thereto. A loss function Ld for a domain discriminant is a categorical cross-entropy function.

In the training, the domain discriminator block 502 learns discriminatory features of character patterns between domains. Gradients back-propagated to the shared layers of the character segmentation network 104 during the training are changed to minus so that invariant features of the character patterns can be learned.

As another example, the feature maps of the fully-labeled text-images 101 and the half-labeled text-images 100 may be directly input from the convolutional block 4 (403) to the domain discriminator block 502. Specifically, the RoI align layer 500 and the feature concatenation layer 501 may be omitted. The domain discriminator block 502 classifies the feature maps into domains corresponding thereto. This approach is sometimes referred to as “global multi-domain adaptation.”

In this manner, the character-level feature maps can be replaced by a whole text-image feature map. The feature pyramid network 103 of the character segmentation network 104 is used to extract whole text-image features, and those features are directly input to the domain discriminator block 502. In this case, the multi-domain adaptation is multi-domain adaptation at a whole text-image feature level.

There is an approach using the hard distance function to match distributions of character-level feature spaces in two regions. However, this approach is not efficient. This is because the contents of input text images are not the same in most cases. In contrast, the domain discriminator block 502 capable of learning can memorize features by updated parameters (weights), to thereby be more flexible and more effective. Domain labels 109 can be examined, revised, and saved by the revising GUI 111. The revised domain labels may be used for the next training iterations.

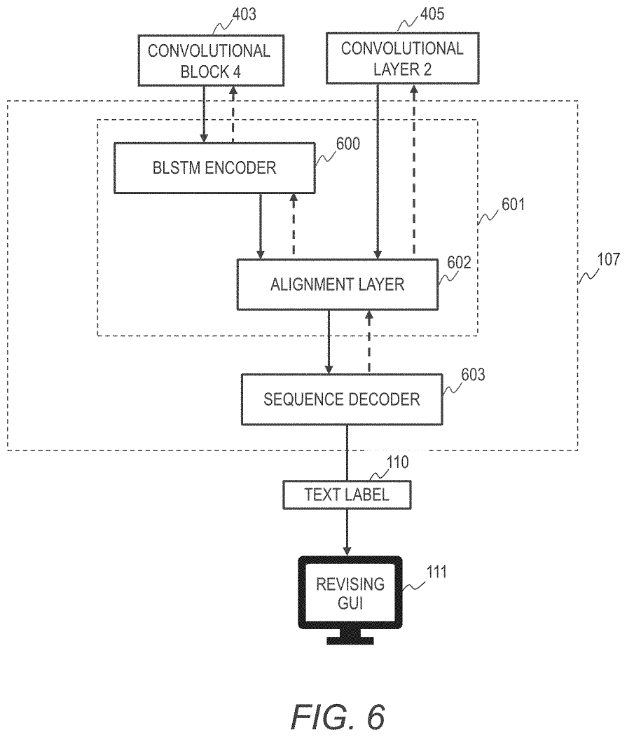

FIG. 6 is a block diagram for illustrating a detailed configuration of the text recognition network 107 in at least one embodiment of the present specification. A combination of a plurality of recurrent neural networks for text-image recognition is illustrated. The feature maps of the fully-labeled text-images 101 extracted at the deepest level 403 of the feature pyramid network 103 are sequentially encoded by a feature encoder (RNN encoder) 601.

In this example, the RNN encoder 601 includes a bidirectional long short-term memory (BLSTM) encoder 600. The BLSTM bidirectionally learns spatial contexts of features. Other examples of the RNN encoder that can be used to replace the BLSTM include a long short-term memory (LSTM) network and gated recurrent units (GRUs).

A hidden encoded feature h tis calculated by a BLSTM hidden unit (BLSTM( )):

H=BLSTM(V)

where V={v_0, v_1, . . . , v_N−1} represents a feature map from the convolutional block 4 (403).

H={h_0, h_1, . . . , h_N−1} are hidden states of the BLSTM encoder 600. The value N represents a width of V. Feature encoding processing is executed by the feature pyramid network 103 and the BLSTM encoder 600. The BLSTM encoder 600 may be sometime omitted (just using the feature pyramid network).

Along a direction of a text line, the bounding boxes of the character patterns on the text-images, which have been proposed by the character segmentation network 104, are sequentially matched to the encoded visual features. The rescaled bounding box of a character pattern a_u is used as a mask to be applied to the encoded visual features, to thereby extract a context vector c_u. The context vector c_u indicates an encoded features (information) to be referred to for character recognition, which has been extracted from the encoded visual feature.

This alignment processing (Align( )) for generating a context vector c_u is performed at the alignment layer 602.

c_u=Align(a_u,H)

The symbol u∈ U represents a number of the character bounding box by the character segmentation network 104, and U represents the total number of character bounding boxes.

With a related-art method, each character in an output sequence may be aligned to any visual features in any orders. In contrast, results of the segmentation of characters are used for the alignment, to thereby limit the encoded visual features to the character position and fix the alignment order.

Next, a sequence decoder (RNN decoder) 603 is a GRU to transform encoded visual features into text labels 110. The GRU may be replaced by an LSTM or any other RNNs. A hidden state s_u of the GRU at a time step “u” is given by a GRU hidden unit (GRU( )) as follows.

s_u=GRU(s_u−1,y_u−1,c_u)

A posterior probability “p” of a character label y_u is generated by applying a soft-max function f as follows.

p(y_u/y_(1:u−1),c_u)=f(s_u)

The hidden state s_u of a current time step depends on not only the context vector c_u thereof but also the previous hidden state s_u−1 and a decoded label y_u−1.

A loss function Lr for training the text recognition network 107 is a categorical cross-entropy loss function. A total training loss L is a sum of Lc, Ld, and Lr, weighted by parameters α, β, and γ as indicated below. No limitations are imposed on values of the weighting parameters.

L=α*Lc+β*Ld+γ*Lr

The text labels 110 may be examined, revised, and saved by the revising GUI 111. The revised text labels may be used for the next training iterations.

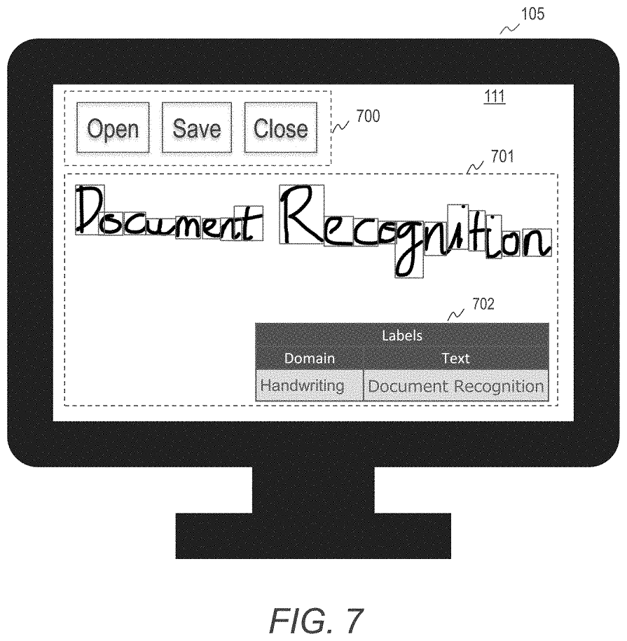

FIG. 7 is an illustration of an example of a revising GUI for revising results obtained by the character segmentation network 104, the multi-domain adaptation network 106, and the text recognition network 107. The revising GUI can be used for examining, revising, and saving character segmentation, character recognition, and domain classification results.

In the example of FIG. 7, the revising GUI 111 displayed on the monitor 306 includes a plurality of control buttons 700. Those control buttons 700 are used for executing operations of, for example, opening an output metadata file, saving edited information of character bounding boxes, domain labels, and text labels to an output metadata file, and closing an output metadata file.

The revising GUI 111 also includes a manipulating window 701 for performing manipulations of, for example, editing, removing, and adding character bounding boxes. The revising GUI 111 can also include a control panel 702 for editing domain labels and text labels.

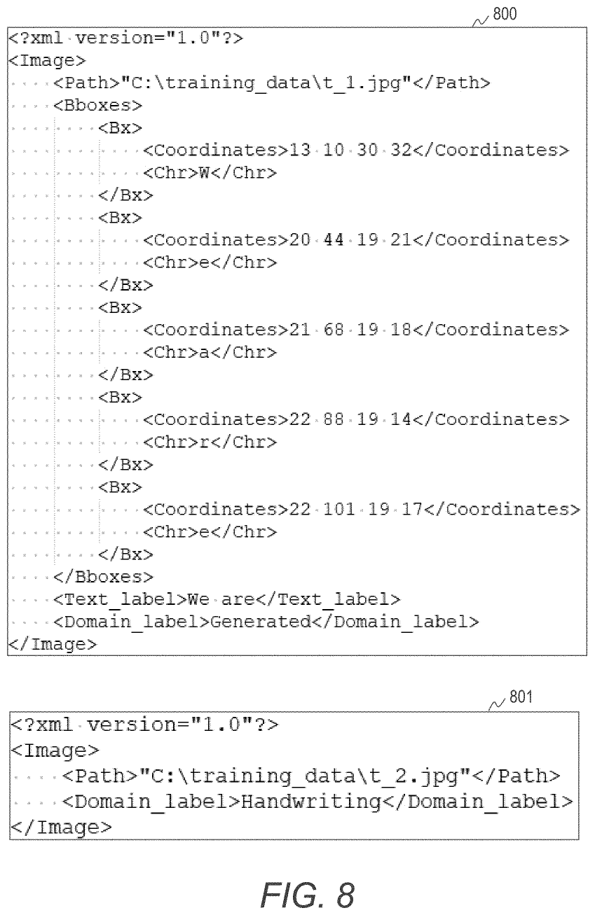

Metadata files are described as FIG. 8. FIG. 8 is an illustration of an example of metadata files for input training data and test output. In FIG. 8, two types of metadata files 800 and 801 are displayed.

The metadata file 800 includes attribute values of the fully-labeled text-image 101, and can include, for example, a file path, character bounding box coordinates, a text label, and a domain label. The metadata file 801 includes attribute values of the half-labeled text-image 100, and can include, for example, a file path and a domain label. The revised output metadata files may be used for the next training iterations.

This invention is not limited to the above-described embodiments but includes various modifications. The above-described embodiments are explained in detail for a better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost all components are actually interconnected.

What is claimed is:

1. A system for training a machine learning model which recognizes characters of text images, the system comprising:
one or more processors; and
one or more storage devices,
wherein the one or more storage devices store the machine learning model which recognizes characters of text images,
wherein the machine learning model which recognizes characters of text images includes:
a character segmentation network which is configured to extract visual features from text images, and to generate character bounding boxes from the text images;
a domain adaptation network configured to classify the text images into domains based on the visual features; and
a text recognition network configured to recognize characters in the text images based on the character bounding boxes and the visual features, and
wherein the one or more processors are configured to:
reverse gradients in training of the domain adaptation network to minus gradients, and to back-propagate the minus gradients through the character segmentation network; and
back-propagate gradients in training of the text recognition network through the character segmentation network.

2. The system according to claim 1, wherein the domain adaptation network is configured to classify the text images into domains based on the character bounding boxes and the visual features.

3. The system according to claim 1, wherein the domain adaptation network includes:
a layer configured to extract feature maps corresponding to the character bounding boxes from the visual features;
a concatenation layer configured to concatenate the extracted feature maps; and
a block configured to discriminate the domains of the text images based on the concatenated feature maps.

4. The system according to claim 1, wherein the text recognition network is configured to align visual features to output sequences by the character bounding box.

5. The system according to claim 1,
wherein the text recognition network includes:
an RNN encoder configured to encode the visual features;
an RNN decoder configured to output character sequences; and
an alignment layer provided between the RNN encoder and the RNN decoder,
wherein the alignment layer is configured to align encoded features obtained from the RNN encoder, to a character sequences by the character bounding boxes obtained by the character segmentation network, and
wherein the RNN decoder is configured to output character sequences from the extracted encoded features.

6. The system according to claim 1, further comprising:
an input apparatus; and
a monitor,
wherein the one or more processors is configured to:
display, on the monitor, output from at least one of the character segmentation network, the domain adaptation network, or the text recognition network; and
receive a revision of the output which has been input from the input apparatus.

7. A method of training a machine learning model which recognizes characters of text images by a system,
the system storing the machine learning model which recognizes characters of text images,
the machine learning model which recognizes characters of text images including:
a character segmentation network which is configured to extract visual features from text images, and to generate character bounding boxes from the text images;
a domain adaptation network configured to classify the text images into domains based on the visual features; and
a text recognition network configured to recognize characters in the text images based on the character bounding boxes and the visual features,
the method comprising:
reversing, by the system, gradients in the training of the domain adaptation network to minus gradients, and backpropagating the minus gradients through the character segmentation network; and
back-propagating, by the system, gradients in the training of the text recognition network through the character segmentation network.

8. The method according to claim 7, further comprising of the domain adaptation network, classifying the text images into domains based on the character bounding boxes and the visual features.
